(19) United States
(12) Patent Application Publication
(10) Pub. No.: US 2010/0312599 A1
(43) Pub. Date: Dec. 9, 2010

(54) System and Method for Measuring Productivity of a Machine

(75) Inventor: Gregory P. Durst, Washington, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/480,216

(22) Filed: Jun. 8, 2009

(51) Int. Cl. G06Q 10/00; G06Q 50/00; G01M 15/05

(52) U.S. Cl. 705/8; 705/7; 701/123

(57) ABSTRACT

A system and method for measuring the productivity of a machine is disclosed. The method includes the steps of: obtaining a digital map of a worksite, indicating a geo-fence on the digital map, where the geo-fence defines a portion of the digital map. The method further includes the steps of associating a task to be completed by the machine within the geo-fence, associating a productivity measure with the task; and measuring a machine parameter associated with performance of the task. The method also includes the step of calculating the productivity measure based on the measurement of the machine parameter.

### TECHNICAL FIELD

This disclosure relates generally to a system and method for measuring the productivity of a machine completing a task at a worksite. More specifically, the disclosed system and method establish a digital map of a worksite, define a subsection of a worksite, associate a task with the subsection, and measure a productivity characteristic of a machine in relation to the task.

### BACKGROUND

Tracking and measuring the productivity of machines at a worksite is valuable for many companies. For example, at a construction site, heavy equipment is often expensive to purchase and maintain. Associated costs also include the cost of skilled labor to operate worksite machines. The owner (or manager and/or operator) of the equipment must therefore ensure that the equipment is properly managed in order to ensure efficiency and profitability.

However, a key component of proper asset management lies in measuring the productivity of a machine. A worksite manager must ensure that proper schedules are met, and that costs incurred in completing tasks on the worksite are in line with expectations. In addition, accurately measuring the productivity of a machine in completing a task on a worksite allows the worksite manager to gather data which is useful in making future cost estimates and bids on future projects.

Systems and methods exist to help worksite managers track and manage assets. For example, U.S. Patent Application No. 2008-0084333 (“Forrest et. al.”) discloses an asset tracking system which allows the manager of a worksite to track the geographic location of an asset, as well as other information about the asset, such as a unique identifier of the asset and other characteristics. Forrest et al. also discloses the use of geo-fences to assist the worksite manager with information about assets at a worksite. In Forrest et al., a user of the system can selectively mark an area of interest on a map, and then obtain an alert when an asset leaves area defined by geo-fence (P142-143).

Although systems such as those disclosed in Forrest et al. provide a worksite manager with information about an asset such as a machine on a worksite, they do not allow for accurate measurement of the productivity in relation to a specific task to be completed at the worksite. Although knowing whether a machine is currently within the boundaries of a geo-fence may be useful for security purposes, or as a general indicator that a machine is working on a particular task, this information alone is often not sufficient for an accurate measurement of the productivity of the machine with respect to specific task.

### SUMMARY

In one aspect, a method for measuring the productivity of a machine is disclosed. The method includes the steps of obtaining a digital map of a worksite, indicating a geo-fence on the digital map, the geo-fence defining a portion of the digital map, and associating a task to be completed by the machine with the geo-fence. The method also includes the steps of associating a productivity measure with the task, and measuring a machine parameter associated with performance of the task. The method also includes the step of calculating the productivity measure based on the measurement of the machine parameter.

In another aspect, a system to measure the productivity of a machine at a worksite is disclosed. The system comprises a digital map of a worksite, a geo-fence defining a portion of the digital map, and a control system. The control system is configured to associate a task to be completed by the machine with the geo-fence, associate a productivity measure with the task. The control system is also configured to measure a machine parameter associated with performance of the task and calculate the productivity measure based on the measurement of the machine parameter.

### BRIEF DESCRIPTION OF THE DRAWINGS

FIG. 1 is a diagram of a digital map of a worksite, with geo-fences defined.

FIG. 2 is a schematic and diagrammatic illustration of an exemplary machine system in one embodiment of the disclosure.

FIG. 3 is a flowchart of an exemplary method according to the present disclosure.

### DETAILED DESCRIPTION

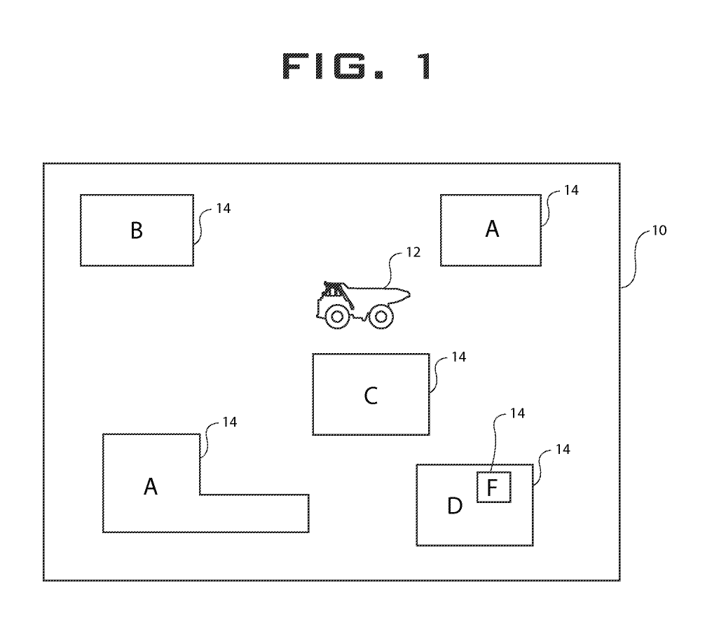

FIG. 1 shows a block diagram of a digital map of a worksite with geo-fences defined. Digital map 10 represents a worksite or a portion thereof. For example, digital map 10 may represent a construction site, a mine site, a quarry, a landfill, or any worksite containing tasks to be completed with the aid of one or more machines. Digital map 10 may be one of a variety of types of maps used to represent a worksite. Digital map 10 may be a satellite image, a topographic map, topological map, a dot map, a road map, or a hybrid map composed from one or more other known map types.

Machine 12 may be represented on digital map 10. Machine 12 may represent a wide variety of machine types, including, but not limited to: trucks, tractors, compactors, graders, dozers, pavers, loaders, scrapers, excavators, automobiles. Machine 12 may be mobile or stationary (e.g., a power generator).

FIG. 1 also shows multiple geo-fences 14. Each different geo-fence 14 is marked “A”, “B”, “C”, “D”, and “F”, respectively in the example. As shown, each geo-fence 14 demarcates a subsection of the area represented by digital map 10. As used herein, the term “geo-fence” is a virtual boundary on a geographic area, i.e., a virtual boundary on a subsection of digital map. As shown in FIG. 1, different geo-fences 14 may demarcate different areas of digital map 10. However, as shown, not all of the area of digital map 10 must necessarily be delineated by a geo-fence.

Moreover, one or more geo-fences may or may not share a common boundary. In addition, geo-fences may also have overlapping areas, such as geo-fences “D” and “F” in FIG. 1. Thus, a particular area on digital map 10 may be a part of two or more geo-fences. Conversely, two or more discrete areas of digital map 10 may be associated with the same geo-fence. For example, in FIG. 1, geo-fence “A” occupies two discrete areas of digital map 10. In addition, although digital map 10 in FIG. 1 is a two-dimensional representation of a worksite, three-dimensional maps and three-dimensional geo-fences may be used as well. Geo-fences may be delineated on digital map 10 in any suitable shape or size known and useful to those skilled in the art.

As shown in the example of FIG. 1, machine 12 is represented on digital map 10, and is not presently inside or at the perimeter of any of the geo-fences 14. This information may be reported to a worksite manager and/or machine operator and may be useful in helping to assess the productivity of the machine.

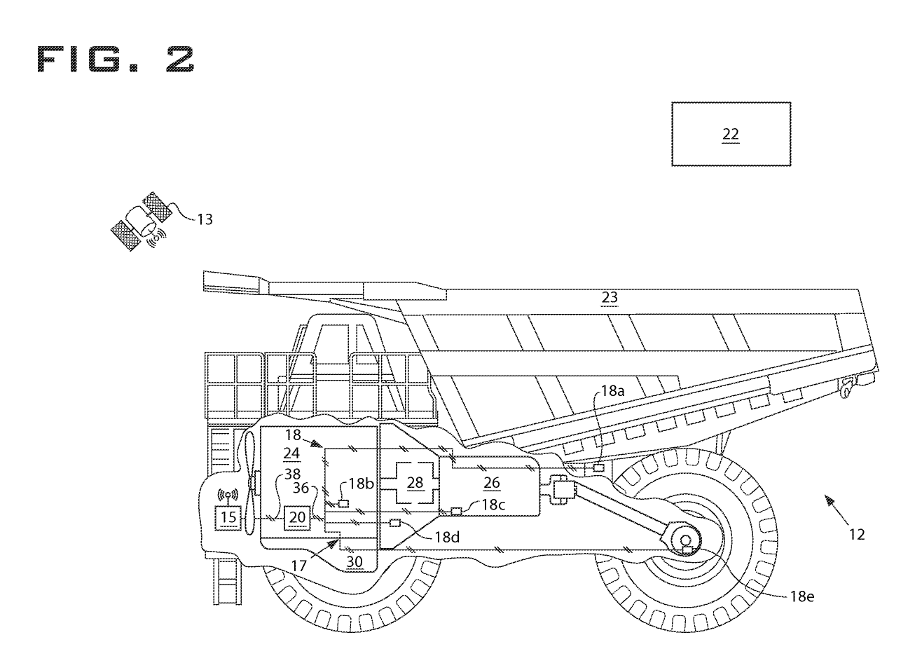

One exemplary system for obtaining information for representing a machine on digital map 10 for measuring its productivity is shown in FIG. 2. Machine 12 may be a mobile machine for performing one or more tasks at a worksite. As discussed above, machine 12 can be a truck (shown in FIG. 2), tractor, compactor, grater, dozer, paver, loader, scraper, excavator, automobile, or any other machine that operates at a worksite. Machine 12 may also embody a stationary device such as a pump system, generator set, or other worksite equipment which operates in a generally stationary manner.

Machine 12 contains an interface control system 17. Interface control system 17 includes components for automatically gathering information from machine 12 during the operation of machine 12. For example, interface control system 17 may include a locating device 15, an interface control module 18, and a controller 20 for communicating with worksite system 22. Locating device 15, interface control module 18, and controller 20 may be separate components or integrated components in a single operable unit on machine 12.

Locating device 15 includes any known locating device that determines the location of machine 12 and generates a signal indicative of the location of machine 12. For example, locating device 15 may be a global positioning system, a local tracking system (such as a system employing radio-frequency identification tags), an inertial reference unit, or other location tracking system known in the art. Controller 20 may receive a signal indicating the position of machine 12, which in turn may be communicated to worksite system 22.

Controller 20 includes one or more hardware or software components for communicating with worksite system 22. This may be accomplished by well known communications protocols, such as standard wireless, cellular, satellite, or similar communications links. Machine 12 need not have a dedicated communication system solely for the purpose of sending data relating to the present disclosure. Machine 12 may be equipped with a communications system which may send a variety of data off-board of machine 12, including any data necessary for systems and methods of the present disclosure, as well as data relating to other systems of machine 12. Further, controller 20 need not send data directly to worksite system 22. For example, machine 12 may send data across a local wireless communication system at the worksite, which may then be routed through another communication network (e.g., the internet) to worksite system 22.

Controller 20 may include one or more components for monitoring, recording, storing, indexing, processing data relating to the interface control system 17. This may include memory or other data storage devices, and other hardware and/or software components necessary to run applications to perform these tasks. For example, controller 20 may include hard disks, optical media, various forms of RAM or ROM, and any other devices well known in the art.

Returning to FIG. 2, controller 20 may be operably coupled to an interface control module 18, which may include a plurality of sensing devices 18a-e distributed throughout machine 12 and configured to gather data from various components and systems of machine 12. Sensing devices 18a-e may be associated with, for example, a work implement 23, a power source 24, a transmission 26, a torque converter 28, a fluid supply 30, and/or other components and subsystems of machine 12. These sensing devices 18a-e may be configured to automatically gather data from the components and subsystems of machine 12 such as, for example, implement, engine, and/or machine speed or location; fluid pressure, flow rate, temperature, contamination level, and/or viscosity; electric current and/or voltage levels; fluid (i.e., fuel, oil, etc.) consumption rates; loading levels (i.e., payload value, percent of maximum allowable payload limit, payload history, payload distribution, etc.); transmission output ratio; transmission gear; cycle time; grade; performed maintenance and/or repair operations; and other such pieces of information. Thus the sensors may include but are not limited to: position sensors, temperature sensors, particle sensors, pressure sensors, and voltage sensors. Additional information may be generated or maintained by interface control module 18 such as the time of day, date, and operator information. The gathered data may be indexed relative to the time, day, date, operator information, or other pieces of information to trend the various operational aspects of machine 12.

In addition to gathering data from an interface control module 18, controller 20 may gather data from an electronic control module on machine 12. This may include the same types of data listed above. In other words, interface control module 18 need not necessarily directly harvest data from sensing devices, and may instead gather machine sensor or state information from one or more electronic control modules on machine 12 that help manage operation of machine 12. The above list provides examples of the types of data available to recorded aboard machine 12, though one of skill in the art will appreciate that the specific type of data will vary according to the type of machine employed in the system.

Controller 20 may also be in communication with the other components of interface control system 17. For example, controller 20 may be in communication with interface control module 18 and locating device 15 via communication lines 36 and 38, respectively. Controller 20 may be configured to send communications to and receive communications from worksite system 22 in response to input from interface control module 18 and/or locating device 15. Likewise, controller 20 may be configured to monitor and/or control operation of interface control module 18 and/or locating device 15 in response to communications from worksite system 22. Various other known power and/or communication circuits may also be associated with controller 20 such as, for example, power supply circuitry, signal-conditioning circuitry, solenoid driver circuitry, communication circuitry, and other appropriate circuitry.

Worksite system 22 may represent one or more computing systems associated with machine 12. The one or more computing systems may include, for example, a laptop, a workstation, a personal digital assistant, a mainframe, a networked computing system, or other computing system known in the art.

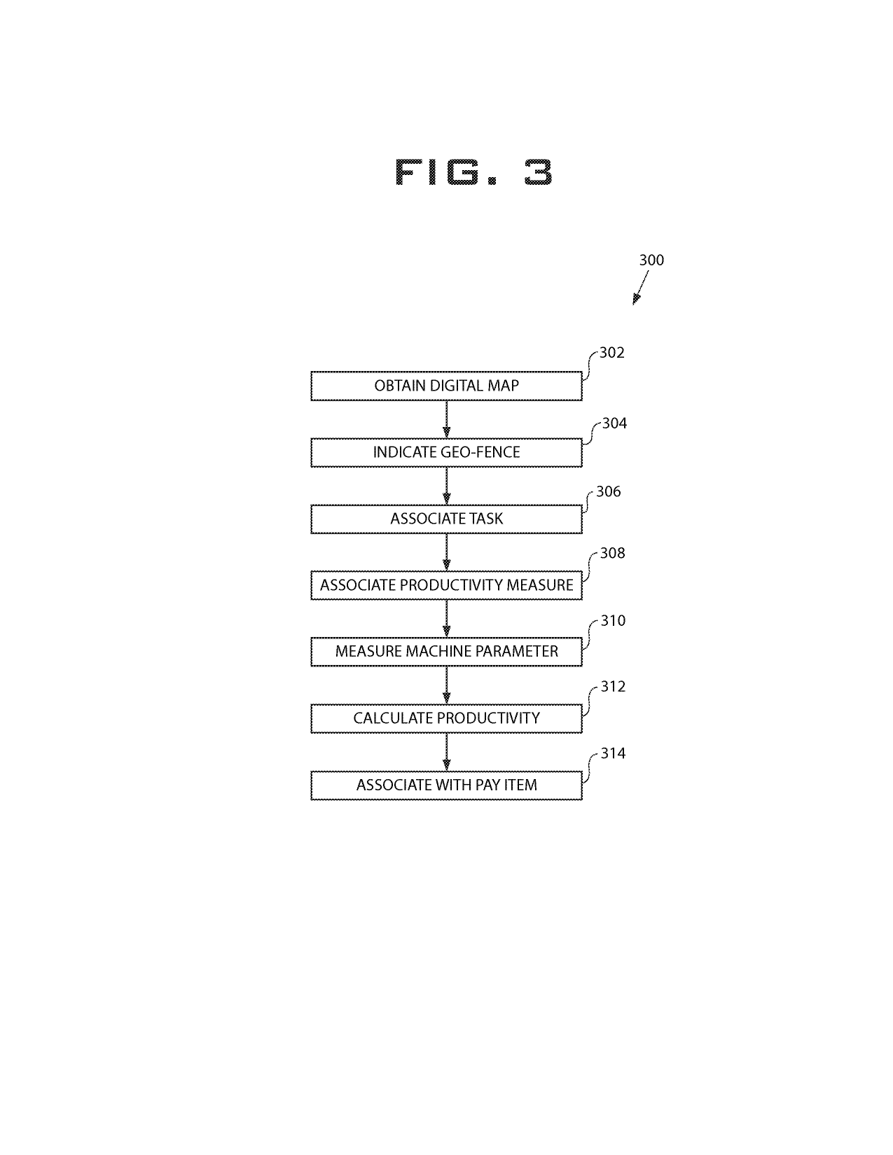

FIG. 3 is a flowchart of an exemplary method 300 in accordance with an embodiment of the disclosure. In the first step, step 302, a worksite manager obtains a digital map of a worksite. As discussed previously, the digital map may be a variety of types of maps representing a worksite. The digital map may be loaded onto the manager's computer or workstation, or loaded into memory from a mainframe system or networked computer system. The digital map represents a worksite or at least a portion of a worksite. Thus, a worksite might be divided into one or more digital maps, and the methods and system disclosed herein would work on the digital maps representing a subsection of the worksite.

In the next step, step 304, a manager indicates a geo-fence on the digital map, where the geo-fence represents a subsection of the area on the digital map. As shown in FIG. 1, a manager may indicate more than one geo-fence on the digital map, and may indicate a geo-fence with the same label on more than one discrete area of the digital map, if necessary. The ability to delimit a map with geo-fences is known in the art. For example, one method is disclosed in U.S. Patent Application No. 2007/0176771.

In addition, although step 304 will usually be performed by a manager using a computer workstation or other electronic device (e.g., a portable electronic device such as a PDA or “smart phone”), step 304 may also be performed automatically, using information obtained from the digital map. For example, the digital map may contain information about the worksite, such as topographical information, that may be used to automatically generate one or more geo-fences, based on the topographical characteristics of the worksite. As an additional example, geo-fences may be automatically generated around roads on the worksite if desirable and if such information is embedded in the digital map. Alternatively, one or more geo-fences may be created by a combination of manager designation and automatic generation.

Returning to FIG. 3, the next step in method 300 is to associate a task to be completed with a geo-fence, step 306. Typically the task associated with the geo-fence will be completed at least in part by one or more machines at the worksite. However, it is not required that the associated task be performed by a single machine, or even be completed solely by machines at the worksite. The disclosed methods and systems may be useful to measure the productivity of one or more machines even if the task is not entirely completed by the one or more of these machines.

In addition, more than one task may be associated with a single geo-fence. Example tasks, including earthmoving tasks, that may be associated with a geo-fence include but are not limited to: material removal, material addition, top soil collection, grading, paving, compacting, pipe laying, building a structure, removing a structure, mining. Any task known in the art to be performed on a worksite may be associated with the geo-fence.

As an example, and returning to FIG. 1, geo-fence “A” may be associated with the task of topsoil collection. Geo-fence “B” may be associated with the task of material removal, and geo-fence “C” may be associated with the task of material fill. A manager may enter this association on a user interface. Alternatively, a task may be automatically associated with a geo-fence based upon information contained in the digital map. As an example, if a map contained information about the location of a resource at a mine site, the task of mining may be automatically associated with one or more geo-fences containing a threshold quantity of the resource to be mined.

Method 300 in FIG. 3 also includes the step of associating a productivity measure with the task, step 308. A productivity measure, as used herein, is a metric to indicate one or more costs incurred with completing a task, and/or to indicate the progress to completion of the task. For example, if the task of material removal is associated with geo-fence “B” in FIG. 1, then one productivity measure may be the number of cycles that a machine in geo-fence “B” has loaded material. This may be related to an additional productivity measure of material moved. Alternatively, another productivity measure for material removal may be the amount of time that a particular machine has operated within geo-fence “B”. In addition, the amount of fuel consumed by a machine while in geo-fence “B” may be another productivity measure. Productivity may also be measured in relation to the amount of time, fuel consumed, or like measurement of a machine when it is outside one or more geo-fences. For example, one may associate a task of hauling material from one geo-fence area to another geo-fence area. A productivity measure may be associated with the time that the machine is in neither geo-fence area. Alternatively, the fuel-consumed by a machine while in neither geo-fence area may be measured to assess productivity.

Returning to FIG. 3, method 300 includes step 310, measuring a machine parameter. This step includes obtaining data from one or more sensors or electronic control modules on a machine. For example, the fuel consumption of the machine may be measured, or the machine's location, or other state data, such as those described previously with respect to FIG. 2. More than one machine parameter may be combined to obtain other machine parameters. These machine parameters may be stored onboard the machine or communicated from the machine (see FIG. 2) to a remote workstation including a data storage device.

In step 312, a productivity measure is calculated based on at least one of the measured machine parameters of step 310. For example, if the productivity measure is labor cost for a given task, then the measured machine parameter containing the time that a machine spent in a particular geo-fence may be computed and multiplied by a known labor cost per hour of the machine operator. The worksite manager may use this to calculate a labor cost for completion of the task.

Data relating to more than one geo-fence, and more than one machine, may be used to calculate a productivity measure in step 312. Returning to FIG. 1, a worksite manager may wish to measure the progress of moving material from geo-fence “B” to geo-fence “C”. In this case, a productivity measure may be calculated using measured machine parameters relating to both geo-fences. For example, a worksite manager may compute the number of cycles completed by a machine moving material from the area represented by geo-fence “B” to the area represented by geo-fence “C”. The number of times that a particular machine left geo-fence area “B” and then subsequently entered geo-fence area “C” may be measured to determine the productivity of the machine. For example, the payload carried by the machine for each trip may be measured from the machine and stored, to compute the total amount of material moved by the machine. Data from more than one machine may be aggregated to determine the total material amount moved.

It should be emphasized that multiple measured machine parameters may also be combined to arrive at potentially more accurate measures of productivity of one or more machines. Returning to the previous example, it may be desirable to measure more machine parameters beyond merely the location of a machine, and when it entered or exited a geo-fence area. For example, to compute the amount of material moved by a machine in the absence of the ability to directly measure payload, an average amount of material hauled may be multiple by the number of cycles that the machine moved material from geo-fence “B” to geo-fence “C.”

However, purely counting the entry and exit of the machine into the various geo-fences may not always represent an accurate measure of productivity. For example, if the machine moved from one geo-fence to another, but carried no payload, then the worksite manager may not wish to include this movement in computing an estimated amount of material moved, or in otherwise using this movement to assess the costs incurred in directly completing the task of moving material. Therefore, the worksite manager may choose to combine data indicative with movement of the machine with data indicative of other machine parameters. For example, the worksite manager may count the number of times that a machine implement moved in a certain fashion, and then the machine moved from geo-fence “B” to geo-fence “C”, followed by another implement movement measurement. This may allow the worksite manager to exclude movements of the machine which did not represent a cycle of moving material from calculating the productivity of the machine.

In step 314, one or more tasks may be associated with a pay item. A “pay item” as used herein is a task, or grouping of tasks, that relate to one or more items associated with payment for a worksite project. It is common that bids or proposals for a worksite include an itemized list of tasks to be completed. These pay items may be associated with one or more tasks at the worksite so that the worksite manager can track the productivity towards completion of a pay item, while still retaining more detailed data that may be used for future cost estimation purposes.

For example, referring again to FIG. 1, geo-fence “A” delineates a borrow pit, geo-fence “B” also delineates a borrow pit, and geo-fence “C” delineates a fill area. The productivity in moving material from geo-fence “A” to geo-fence “C” may be tracked, and the productivity in moving material from geo-fence “B” to geo-fence “C” may also be separately tracked. This data may be individually and separately stored, in case the worksite manager wishes to recall the costs of moving material from geo-fence “A” to geo-fence “C” for future cost estimation purposes (e.g., future bidding on a task that closely resembles this task). However, for purposes of determining the progress to completion of the pay item on the job site these two tasks may be associated with a single pay item, and a combined productivity measure for the pay item tracked.

It should be noted that the steps listed in FIG. 3 do not necessarily need to be performed in the exact order described. For example, step 310 may be performed prior to previous steps. As another example, step 308 may be performed prior to step 306.

Additional steps may be performed along with the steps shown in FIG. 3. For example, the productivity measures may be displayed on a user interface allowing a worksite manager to obtain information about the status of specific tasks at a worksite in real-time or near real-time. In addition, one or more tasks associated with one or more geo-fences may in turn be associated with a pay item relating to the project contract. This allows a worksite manager to use the method and system disclosed herein to not only track productivity in real-time or near-real time, but also to track or estimate the amount presently earned under a contract for the worksite.

The data gathered about the productivity of completing one or more tasks also provides a dataset that may allow a worksite manager to better estimate the costs of a task on a future project. For example, when estimating the cost of completing a future project, the worksite manager can break the project into one or more tasks, and compare the task to the tasks performed on previous projects. By employing the present method and system herein, the worksite manager can build a set of historical data about the costs incurred in performing various specific tasks, rather than simply the total cost of an entire project. By comparing historical task data to comparable tasks on future project, the worksite manager may be able to produce a more precise estimate of the costs of performing the future task.

### INDUSTRIAL APPLICABILITY

The present disclosure provides advantageous systems and methods for measuring the productivity of a machine completing a task at a worksite. The disclosed systems and methods may be employed in the following projects, among other areas: residential and commercial construction, earthmoving, mining, hauling, quarries, landfills, road construction. Other embodiments, features, aspects, and principles of the disclosed examples will be apparent to those skilled in the art and may be implemented in various environments and systems.

What is claimed is:

1. A method for measuring the productivity of a machine, comprising:
obtaining a digital map of a worksite;
indicating a geo-fence on the digital map, the geo-fence defining a portion of the digital map;
associating a task to be completed by the machine with the geo-fence;
associating a productivity measure with the task;
measuring a machine parameter associated with performance of the task; and
calculating the productivity measure based on the measurement of the machine parameter.

2. The method of claim 1, wherein the productivity measure is at least one of: cost, fuel consumption, or average material moved.

3. The method of claim 1, wherein the step of calculating the productivity measure based on the measurement of the machine parameter includes calculating the amount of time that the machine was within the geo-fence.

4. The method of claim 1, including the step of using the productivity measure at least in part to estimate a cost of the task.

5. The method of claim 4, including the step of calculating progress to completion of the task based at least in part on the machine parameter.

6. The method of claim 1, wherein the step of calculating the productivity measure based on the measurement of the machine parameter includes determining whether the measured machine parameter occurred within the geo-fence.

7. The method of claim 1, including the step of associating a task with a pay item.

8. The method of claim 7, wherein a plurality of tasks are associated with a single pay item, and including the step of separately storing data relating to the productivity of each task.

9. A system to measure the productivity of a machine at a worksite, the system comprising:
a digital map of a worksite;
a geo-fence defining a portion of the digital map; and
a control system configured to:
associate a task to be completed by the machine with the geo-fence;
associate a productivity measure with the task;
measure a machine parameter associated with performance of the task; and
calculate the productivity measure based on the measurement of the machine parameter.

10. The system of claim 9, including a user interface for displaying the productivity measure.

11. The system of claim 9, wherein the control system is further configured to use the productivity measure to estimate the cost of a task.

12. The system of claim 9, including the step of calculating progress to completion of the task based at least in part on the measured machine parameter.

13. The system of claim 9, wherein the at least one machine parameter includes one of: engine speed, engine rpm, position of a hydraulic cylinder.

14. The system of claim 9, wherein the productivity measure is one of: cost, fuel consumption, average material moved.

15. The system of claim 9, wherein the control system is further configured to associate a plurality of tasks with a pay item.

16. The system of claim 15, including the step of measuring the progress to completion of the pay item based on the combination of productivity measures associated with the plurality of tasks associated with the pay item.

17. The system of claim 9, wherein the step of calculating the productivity measure based on the measurement of the machine parameter includes determining whether the machine parameter occurred in geo-fence.

18. A system to measure the productivity of an earthmoving task at a worksite, the system comprising:
a digital map of a worksite;
a geo-fence defining a portion of the digital map; and
a control system configured to:
associate an earthmoving task to be completed by the machine with the geo-fence;
associate a productivity measure with the earthmoving task;
measure a machine parameter associated with performance of the earthmoving task; and
calculate the productivity measure based on the measurement of the machine parameter.

19. The system of claim 18, wherein the control system is further configured to associate a plurality of earthmoving tasks with a single pay item.

20. The system of claim 19, wherein the control system is further configured to separately store data associated with the plurality of earthmoving tasks.
